(19) United States
(12) Patent Application Publication
(10) Pub. No.: US 2026/0031677 A1
(43) Pub. Date: Jan. 29, 2026

(54) Motor System

(71) Applicant: Lenze Swiss AG, Romanshorn (CH)

(72) Inventors: Hans-Peter HUTH, Arbon (CH); Daniel BOROWSKI, Guettingen (CH)

(21) Appl. No.: 18/868,503

(22) PCT Filed: May 23, 2023
(86) PCT No.: PCT/EP2023/063796

§ 371 Date: Sep. 17, 2025

(30) Foreign Application Priority Data
May 25, 2022 (DE) 10 2022 205 277.3

(51) Int. Cl. H02K 5/22; H02K 11/00; H02K 11/30

(52) U.S. Cl. CPC H02K 5/225; H02K 11/0094; H02K 11/30

(57) ABSTRACT

A motor system includes an electric motor and a frequency converter for controlling the electric motor, wherein the frequency converter has a circuit board with conductor paths. The circuit board is to be electrically connected to the electric motor via a wire-to-board connection. The wire-to-board connection has: through-openings in the circuit board; electrically conductive contact elements which are inserted into the through-openings in the circuit board, which are electrically contacting corresponding conductor paths on the circuit board, and which have through-openings; and a pin terminal having pin contacts, which are to be introduced into corresponding through-openings of the contact elements to form an electrical contact with the contact elements, and which has terminal contacts that are electrically connected to the pin contacts, into which corresponding motor conductors can be introduced in order to electrically connect the motor conductor to a corresponding conductor path of the circuit board.

### BACKGROUND AND SUMMARY

The invention relates to a motor system with an electric motor and a frequency converter for the actuation of the electric motor, which enables as simple as possible electrical contacting between frequency converter and electric motor.

The motor system has a conventional electric motor, for example, in the form of a three-phase asynchronous or synchronous motor.

The motor system furthermore has a frequency converter for actuation of the electric motor. The frequency converter has at least one printed circuit board with track conductors guided thereon, wherein the printed circuit board is to be electrically connected or is electrically connected to the electric motor by means of a wire-to-board connection. In relation to the fundamental properties of wire-to-board connections, reference is also made to the relevant expert literature.

The wire-to-board connection according to the invention has in particular circular-cylindrical through-openings or bores in the printed circuit board. For example, nine through-openings can be provided.

The wire-to-board connection furthermore has electrically conductive contact elements which are inserted into corresponding through-openings of the printed circuit board and which are electrically contacted with corresponding track conductors on the printed circuit board. For this purpose, the through-openings can be bordered or delimited, for example, by metalized surfaces which are in turn electrically contacted with corresponding track conductors. The electrically conductive contact elements have, in their interior, through-openings, for example, in the form of radially central, circular-cylindrical and axially running bores.

The wire-to-board connection furthermore has a pin terminal which forms a detachable plug-in connection with the electrically conductive contact elements.

The pin terminal has pin contacts, in particular with a circular-cylindrical cross-section, which are to be introduced or are introduced into corresponding through-openings of the electrically conductive contact elements in order to produce the plug-in connection or form an electrical contact with the electrically conductive contact elements. Inverse spring contacts which realize the connection to the corresponding pin contact can be provided within the contact elements or within their through-openings.

The pin terminal furthermore has terminal contacts connected electrically to the pin contacts, into which terminal contacts corresponding motor conductors for intended use are introduced in order to electrically connect the motor conductor to a corresponding track conductor of the printed circuit board. The pin contacts and the terminal contacts can be embodied in one piece. The terminal contacts can be embodied as screw terminal contacts, spring terminal contacts, etc. The motor conductors are electrically connected, for example, to phase connections of the electric motor.

In one embodiment, the pin terminal furthermore has: housing elements, wherein a pin contact and a corresponding terminal contact are mounted in a corresponding housing element, in particular in a floating manner. The housing elements can be connected to one another or be formed in one piece.

In one embodiment, the wire-to-board connection furthermore has: a centering and holding element which is formed to receive the housing elements and to fix them mechanically in a defined position, wherein the centering and holding element has dowel pins which are provided to be introduced into corresponding dowel openings of the printed circuit board.

In one embodiment, the motor system furthermore has: a trough element, wherein the printed circuit board is arranged in the trough element. The trough element has through-openings, the positions of which correspond to positions of the through-openings of the printed circuit board, for example, by virtue of the fact that these have an identical modular dimension to the through-openings of the printed circuit board. The through-openings of the trough element serve in particular as introduction and centering aids for the pin contacts in the course of the plugging in of the pin contacts. The through-openings can, for example, be conically shaped in order to facilitate an introduction of the pin contacts.

In one embodiment, the inner through-openings of the contact elements are formed to be circular-cylindrical, for example, as circular-cylindrical through-bores.

In one embodiment, the contact elements are formed from two vertically stacked circular cylinders with different diameters.

In one embodiment, the motor system furthermore has: an adapter element, wherein the pin terminal is received and mechanically fixed in the adapter element.

In one embodiment, the adapter element has fastening elements for mounting on the electric motor and/or for wall mounting. Depending on the manner of the intended mounting, various types of adapter elements can be provided so that the motor system according to the invention can be used flexibly.

The invention is described below in detail with reference to the drawings.

### BRIEF DESCRIPTION OF THE DRAWINGS

FIG. 1 is a perspective view of a motor system according to an embodiment of the invention with an electric motor and a frequency converter for the actuation of the electric motor;

FIG. 2 is a first perspective view of a printed circuit board of the frequency converter which is electrically connected to the electric motor by means of a wire-to-board connection;

FIG. 3 is a second perspective view of the printed circuit board of the frequency converter;

FIG. 4 is a perspective view of an electrically conductive contact element which is a component of the wire-to-board connection;

FIG. 5 is a perspective view of a trough element with through-openings which are formed as introduction and centering aids; and

FIG. 6 is a perspective view of an adapter element which is used in the context of the mounting of the motor system according to an embodiment of the invention.

### DETAILED DESCRIPTION OF THE DRAWINGS

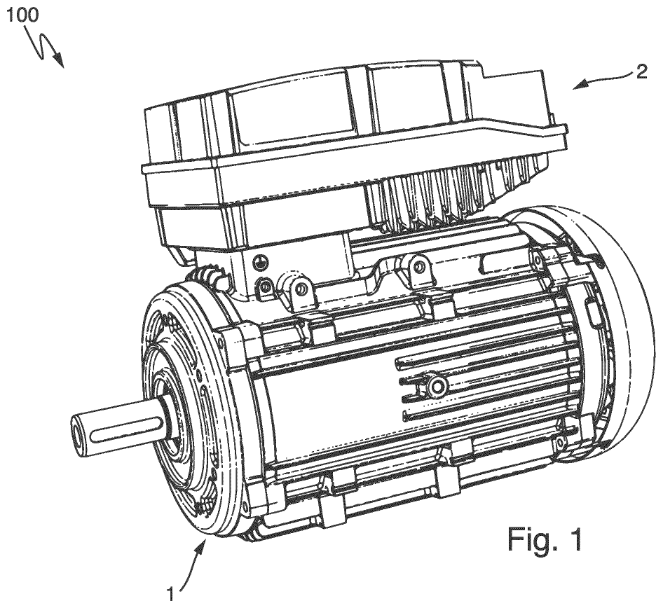

FIG. 1 shows a perspective view of a motor system 100 with an electric motor 1 and a frequency converter 2 for the actuation of the electric motor 1.

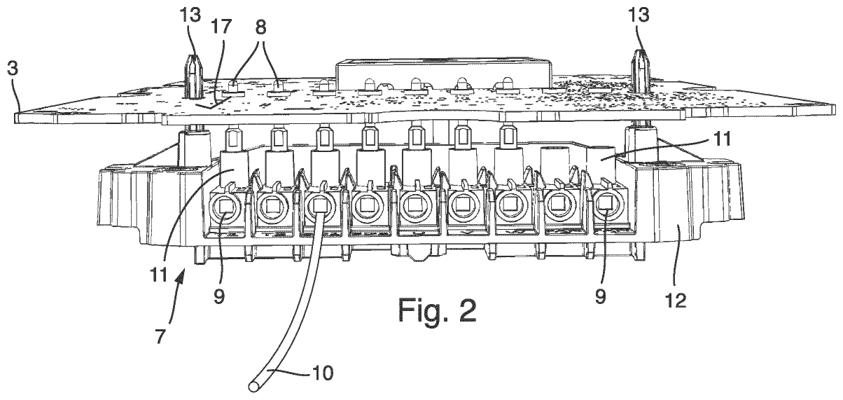

FIG. 2 shows a printed circuit board 3 of the frequency converter 1 with a track conductor 17 represented by way of example thereon. The printed circuit board 3 is to be electrically connected or is electrically connected to the electric motor 1 by means of a wire-to-board connection described in detail below.

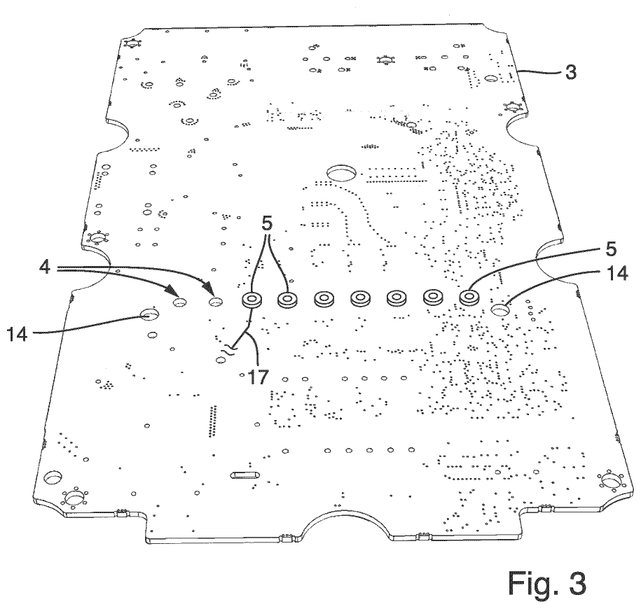

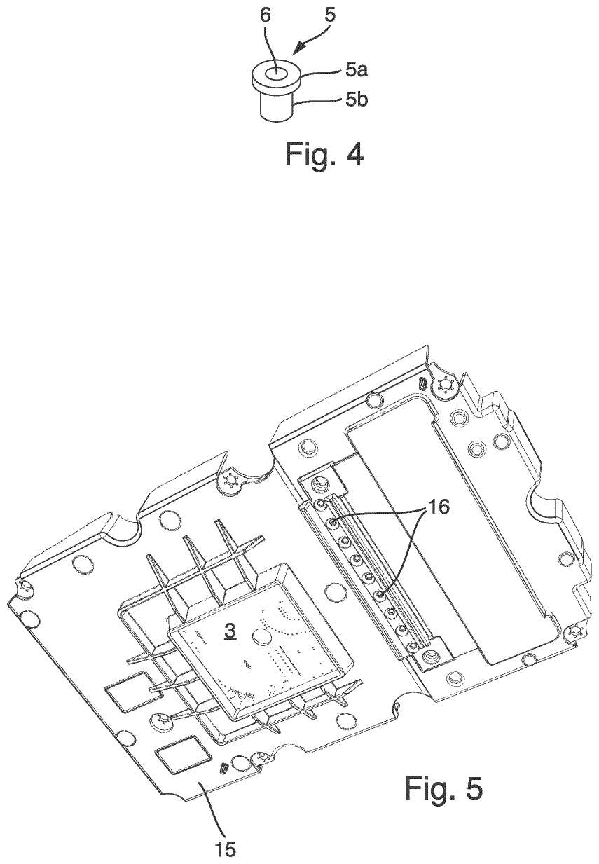

With reference to FIG. 3, the wire-to-board connection has (printed circuit board) through-openings 4 in the printed circuit board 3 and electrically conductive contact elements 5 which are inserted into the through-openings 4 of the printed circuit board 3 which are electrically contacted with corresponding track conductors 17 on the printed circuit board 3 and which have circular-cylindrical (contact element) through-openings 6, see in this regard FIG. 4. Merely for depiction reasons, no electrically conductive contact elements 5 are inserted in FIG. 3 into two through-openings 4 of the printed circuit board 3. However, it is also possible to partially also not fit contact elements 5 if the associated connections are not required.

With reference to FIG. 2, the wire-to-board connection has a pin terminal 7 which has pin contacts 8 which are to be introduced into corresponding through-openings 6 of the contact elements 5 to form an electrical contact with the contact elements 5 or the associated track conductors 17 and which has terminal contacts 9 electrically connected to the pin contacts 8, into which terminal contacts 9 corresponding motor conductors 10 are introduced in order to electrically connect the motor conductor 10 to a corresponding track conductor 17 of the printed circuit board 3. For depiction reasons, only a single motor conductor is represented.

The pin terminal 7 furthermore has housing elements 11, wherein a pin contact 8 and a corresponding terminal contact 9 are mounted in a corresponding housing element 11 in a floating manner. The housing elements 11 are connected in one piece to one another.

The wire-to-board connection furthermore has a centering and holding element 12, which is formed to receive the housing elements 11 and mechanically fix them in a defined position. The centering and holding element 12 has dowel pins 13 which are provided to be introduced into corresponding dowel openings 14 of the printed circuit board 3, see FIG. 3.

With reference to FIG. 5, the motor system 100 furthermore has a trough element 15, wherein the printed circuit board 3 is arranged in the trough element 15. The trough element 15 has (trough element) through-openings 16, the positions of which correspond to positions of the through-openings 4 of the printed circuit board 3. The through-openings 16 of the trough element serve as introduction and centering aids for the pin contacts 8 and are conically shaped for this purpose.

With reference to FIG. 4, the contact elements 5 are formed from two vertically stacked circular cylinders 5a, 5b with different diameters.

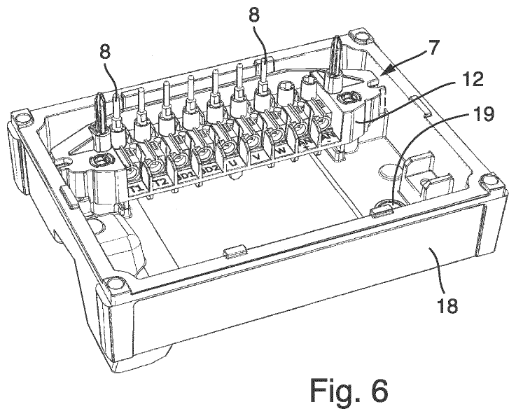

With reference to FIG. 6, the motor system 100 furthermore has an adapter element 18, wherein the pin terminal 7 is received and mechanically fixed in the adapter element 18.

The adapter element 18 can have fastening elements 19, for example, in the form of mounting holes, for mounting on the electric motor 1 and/or for wall mounting.

The problem of a wire-to-board contacting for power and signal contacts, in the present case, for example, connections for motor, parking brake, PTC and fan, is solved by means of the invention by an unfitted underside of the printed circuit board to corresponding terminal points (spring-loaded or screw terminal) for fastening lines in the case of limited space conditions, in particular installation height. The motor system according to the invention enables a very small installation height and is furthermore highly cost-efficient in comparison with a conventional plug-in connection. The motor system according to the invention is furthermore easy to produce in series manufacture.

1-9. (canceled)

10. A motor system, comprising:
an electric motor; and
a frequency converter for actuation of the electric motor, wherein the frequency converter comprises a printed circuit board with track conductors and a wire-to-board connection,
wherein the printed circuit board is to be electrically connected to the electric motor via the wire-to-board connection,
the wire-to-board connection comprising:
(i) through-openings in the printed circuit board,
(ii) electrically conductive contact elements,
which are inserted into the through-openings of the printed circuit board,
which are electrically contacted with corresponding track conductors on the printed circuit board, and
which have through-openings, and
(iii) a pin terminal comprising:
pin contacts which are to be introduced into corresponding through-openings of the contact elements in order to form an electrical contact with the contact elements, and
terminal contacts electrically connected to the pin contacts, into which terminal contacts corresponding motor conductors are introduced in order to electrically connect the motor conductor to a corresponding track conductor of the printed circuit board.

11. The motor system according to claim 10, wherein the pin terminal further comprises:
housing elements, wherein a pin contact and a corresponding terminal contact are mounted in a corresponding housing element.

12. The motor system according to claim 11, wherein the mounting is in a floating manner.

13. The motor system according to claim 11, wherein the wire-to-board connection further comprises:
a centering and holding element which is formed to receive the housing elements and to fix them mechanically in a defined position,
wherein the centering and holding element has dowel pins which are provided to be introduced into corresponding dowel openings of the printed circuit board.

14. The motor system according to claim 10, further comprising:
a trough element,
wherein the printed circuit board is arranged in the trough element, and
wherein the trough element has through-openings, positions of which correspond to positions of the through-openings of the printed circuit board.

15. The motor system according to claim 14, wherein
the through-openings of the trough element are conically shaped as an introduction and centering aid for the pin contacts.

16. The motor system according to claim 10, wherein
the through-openings of the contact elements are formed to be circular-cylindrical.

17. The motor system according to claim 10, wherein
the contact elements are formed from two vertically stacked circular cylinders with different diameters.

18. The motor system according to claim 10, further comprising:
an adapter element, wherein the pin terminal is received and mechanically fixed in the adapter element.

19. The motor system according to claim 18, wherein
the adapter element has fastening elements for mounting on the electric motor and/or for wall mounting.
